(19) United States
(12) Patent Application Publication
(10) Pub. No.: US 2011/0310488 A1
(43) Pub. Date: Dec. 22, 2011

(54) DISPLAY DEVICE AND METHOD OF MANUFACTURING SAME

(75) Inventors: Takuma Tomotoshi, Osaka-shi (JP); Hisashi Watanabe, Osaka-shi (JP)

(73) Assignee: SHARP KABUSHIKI KAISHA, Osaka-shi, Osaka (JP)

(21) Appl. No.: 13/148,319

(22) PCT Filed: Feb. 9, 2010
(86) PCT No.: PCT/JP2010/000779

§ 371 Date: Aug. 8, 2011

(30) Foreign Application Priority Data
Feb. 10, 2009 (JP) 2009-029107

(51) Int. Cl. G02B 1/11; B32B 38/10; B32B 37/12; B32B 37/02

(52) U.S. Cl. 359/601; 156/60; 156/250; 156/256

(57) ABSTRACT

A direct-viewing type display device 100A includes: at least one display panel 10 which has a display region 10A and a frame region 10F provided outside the display region, the display region 10A and the frame region 10F being separated by a boundary B1 extending in a first direction D1; and at least one light-transmitting cover 20 provided on a viewer side of the at least one display panel 10. The at least one light-transmitting cover 20 includes a lens portion 22 which is disposed astride the boundary B1, the lens portion 22 being configured to refract part of light going out from the display region 10A in the frame region 10F. A light exit surface 22a of the lens portion 22 is a curved surface, and at least part of the light exit surface 22a is provided with an antireflection treatment. According to the present invention, a direct-viewing type display device is provided in which the frame region of the display panel is obscured, and reflection of the environment in the lens portion is prevented.

### TECHNICAL FIELD

The present invention relates to a display device and a method of manufacturing a display device, and more particularly to a direct-viewing type display device and a method of manufacturing a direct-viewing type display device.

### BACKGROUND ART

Traditionally, in television sets and display devices for displaying information, attempts have been made at realizing a pseudo large-screen display device by arraying a plurality of display devices (which may be referred to as a tiling technique). However, using the tiling technique has a problem of visible joints between the plurality of display devices.

This problem is now described by taking a liquid crystal display device for example. A liquid crystal display device includes a liquid crystal display panel, a backlight device, circuits for supplying various electrical signals to the liquid crystal display panel, and a power supply, as well as a housing in which to accommodate these. The liquid crystal display panel includes a pair of glass substrates and a liquid crystal layer provided between them. On one of the pair of glass substrates, for example, pixel electrodes, TFTs and bus lines are disposed. On the other glass substrate, color filter layers and a counter electrode are disposed. Moreover, the liquid crystal display panel has a display region in which a plurality of pixels are arrayed, and a frame region around it. In the frame region, a sealing portion for ensuring that the pair of substrates oppose each other and also sealing and retaining the liquid crystal layer, an implementation of driving circuitry for driving the pixels, and the like are provided.

Since no pixels are arrayed in the frame region, the frame region does not contribute to displaying. Thus, when constructing a large screen by arraying a plurality of liquid crystal display panels, joints will occur in the image. This problem is not limited to liquid crystal display devices, but is a problem common to direct-viewing type display devices, e.g., PDPs, organic EL display devices, and electrophoresis display devices.

Patent Documents 1 and 2 disclose a display device for displaying a jointless image on a display panel. The display devices described in Patent Documents 1 and 2 include a light-transmitting cover on the viewer's side of the display panel. An edge portion of the light-transmitting cover includes a portion in which the viewer-side surface is curved. The curved portion functions as a lens, and therefore will be referred to as a “lens portion” hereinafter. The lens portion of the light-transmitting cover is provided so as to overlap the frame region of the display panel and a portion of a region of the display region adjoining the frame region. A portion of the display region that overlaps the lens portion will be referred to as a “peripheral display region”. Light which goes out from pixels which are arrayed in the peripheral display region is refracted by the lens portion in the frame region. As a result, an image is also displayed on the front face of the frame region, so that a jointless image is displayed on the entire screen.

### CITATION LIST

### Patent Literature

Patent Document 1: Japanese Laid-Open Patent Publication No. 2000-180964

Patent Document 2: Japanese PCT National Phase Laid-Open Publication No. 2004-524551

### SUMMARY OF INVENTION

### Technical Problem

However, the present inventor conducted researches and found that the display devices described in Patent Document 1 and Patent Document 2 have a problem which will be described below. The problem will be described with reference to FIG. 22.

FIG. 22 shows a schematic cross-sectional view of a display device 400 which includes a display panel 410 and a light-transmitting cover 420. The light exit surface of the light-transmitting cover 420 is curved, so that external light rays coming in a lens portion 422 at different angles are reflected toward a viewer. Therefore, in the lens portion 422, reflection of the environment frequently occurs so that the display quality is low.

The present invention was conceived for the purpose of solving the above problem. One of the objects of the present invention is to provide a display device in which the frame region of the display panel is obscured, and reflection of the environment on the lens portion is prevented.

### Solution to Problem

A direct-viewing type display device of the present invention includes: at least one display panel which has a display region and a frame region provided outside the display region, the display region and the frame region being separated by a boundary extending in a first direction; and at least one light-transmitting cover provided on a viewer side of the at least one display panel; wherein the at least one light-transmitting cover includes a lens portion which is disposed astride the boundary, the lens portion being configured to refract part of light going out from the display region in the frame region, and a light exit surface of the lens portion is a curved surface, at least part of the light exit surface being provided with an antireflection treatment.

In one embodiment, the display device further includes an antireflection film. The antireflection film is attached onto the light exit surface of the lens portion and a side surface of the lens portion via an adhesion layer. An edge of part of the antireflection film which is attached onto the side surface of the lens portion is on the side surface of the lens portion.

In one embodiment, the display device further includes an antireflection film. The antireflection film is attached onto the light exit surface of the lens portion, a side surface of the lens portion, and a rear surface of the lens portion via an adhesion layer. An edge of part of the antireflection film which is attached onto the rear surface of the lens portion is on the frame region side of the boundary.

In one embodiment, the display device further includes an antireflection film. The antireflection film is attached onto the light exit surface of the lens portion, a side surface of the lens portion, and a side surface of the at least one display panel via an adhesion layer. An edge of part of the antireflection film which is attached onto the side surface of the display panel is on the side surface of the display panel.

In one embodiment, the display device further includes an antireflection film. The antireflection film is attached onto the light exit surface of the lens portion, a side surface of the lens portion, a side surface of the at least one display panel, and a rear surface of the at least one display panel via an adhesion layer. An edge of part of the antireflection film which is on the rear surface of the display panel is on the frame region side of the boundary.

In one embodiment, a corner of the lens portion at which the light exit surface and the side surface of the lens portion meet each other has a curved surface.

In one embodiment, a corner of the lens portion at which the light exit surface and the side surface of the lens portion meet each other has a curved surface, and another corner of the lens portion at which the side surface and the rear surface of the lens portion meet each other has a curved surface.

In one embodiment, the display device further includes a protection tape which includes a support layer and a first adhesion layer provided on one surface of the support layer. The protection tape is attached so as to cover an edge of part of the antireflection film which is attached onto the side surface of lens portion and the side surface of the lens portion.

In one embodiment, the protection tape further includes a second adhesion layer provided on the other surface of the support layer. The at least one display panel includes two display panels arranged so as to adjoin each other along a second direction which is perpendicular to the first direction. The at least one light-transmitting cover includes two light-transmitting covers arranged so as to adjoin each other along the second direction. The lens portions of the two light-transmitting covers adjoin each other along the second direction. The lens portions of the two light-transmitting covers are covered with the antireflection film via an adhesion layer. The two light-transmitting covers are united together by means of the protection tape. A dimension along the second direction of the side surface of the lens portions of the two light-transmitting covers is not more than 100 μm.

A display device fabrication method of the present invention includes the steps of: (a) providing a light-transmitting cover which includes a lens portion at its edge, a light exit surface of the lens portion being formed by a curved surface; (b) attaching an antireflection film onto the light exit surface of the lens portion via an adhesion layer with pressure; and (c) after step (b), attaching the antireflection film onto a side surface of the lens portion with pressure.

In one embodiment, the display device fabrication method further includes, between step (a) and step (b) or between step (b) and step (c), step (d) of cutting the antireflection film such that an edge of part of the antireflection film attached onto the side surface is present on the side surface of the lens portion.

In one embodiment, step (a) includes providing a display panel unit, the display panel unit including a display panel and the light-transmitting cover.

In one embodiment, the antireflection film is an LR film.

In one embodiment, the antireflection film has a motheye structure.

In one embodiment, the antireflection film is a dielectric multilayer film.

In one embodiment, the display device further includes a buffer layer. The buffer layer is interposed between the rear surface of the at least one light-transmitting cover and a display surface of the at least one display panel. The refractive index of the buffer layer is equal to the refractive index of the at least one light-transmitting cover and to the refractive index of a component provided on the viewer's side of the at least one display panel.

In one embodiment, the buffer layer is made of a UV-curable resin.

Another display device of the present invention includes: at least one display panel that has a display region in which a plurality of pixels are arrayed and a frame region provided outside the display region, the display region and the frame region being separated by a boundary extending in a first direction; and at least one light-transmitting cover provided on a viewer side of the at least one display panel. The at least one light-transmitting cover includes a lens portion which is disposed astride the boundary, the lens portion being configured to refract part of light going out from the display region in the frame region. The lens portion is configured to refract light rays going out from the plurality of pixels arrayed in the display region in such a manner that the light rays occur at a generally constant pitch across a plane perpendicular to the first direction. A line of intersection between the plane perpendicular to the first direction and a light exit surface of the lens portion is a curve which is not a circular arc.

In one embodiment, the intersection line is a curve which is defined by an aspherical function.

Still another display device of the present invention includes: at least one display panel which has a display region and a frame region provided outside the display region, the display region and the frame region being separated by a boundary extending in a first direction; and at least one light-transmitting cover provided on a viewer side of the at least one display panel. The at least one light-transmitting cover includes a lens portion which is disposed astride the boundary, the lens portion being configured to refract part of light going out from the display region in the frame region. A light exit surface of the lens portion is a curved surface, and a rear surface of the lens portion is also a curved surface.

### ADVANTAGEOUS EFFECTS OF INVENTION

According to the present invention, a direct-viewing type display device is provided in which the frame region of the display panel is obscured, and reflection of the environment in the lens portion is prevented.

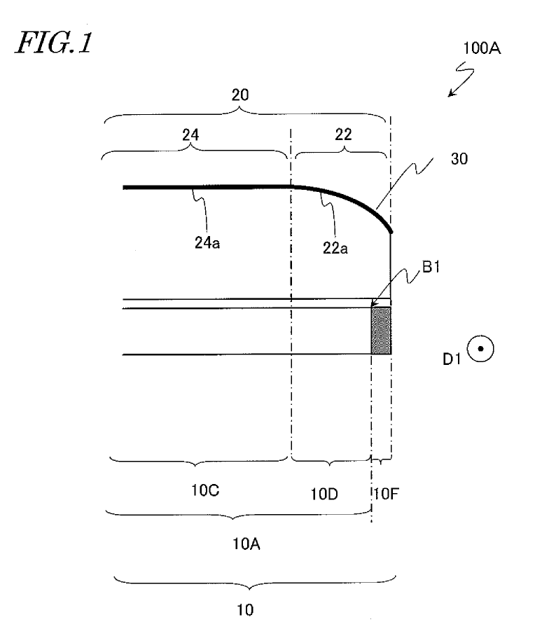

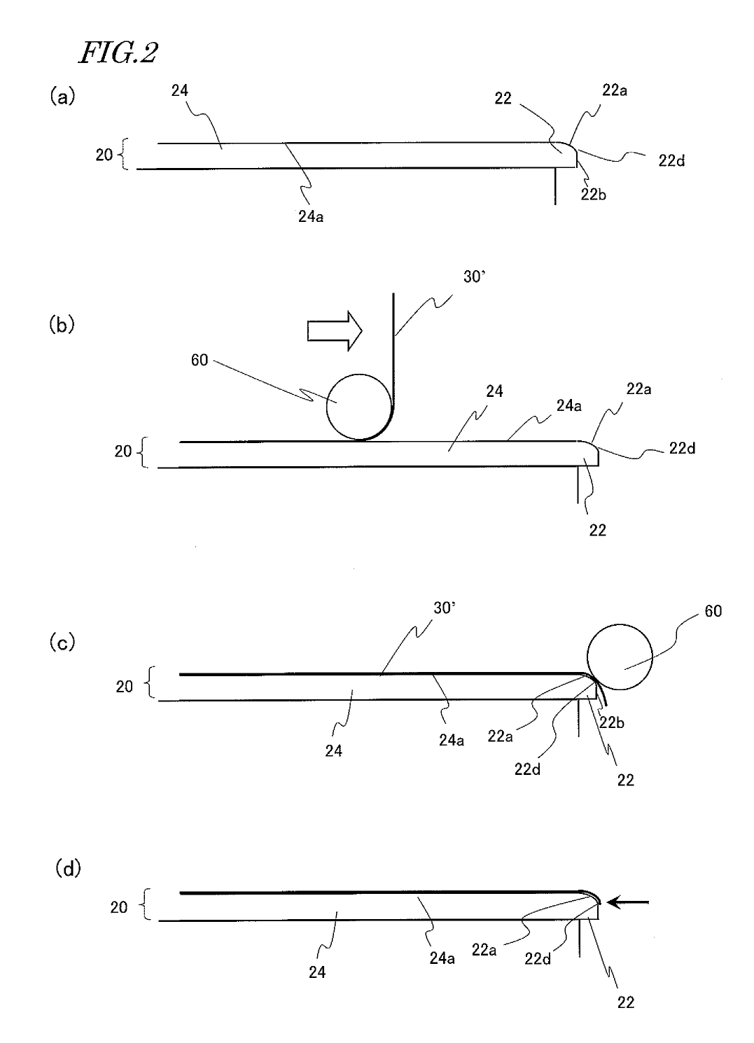

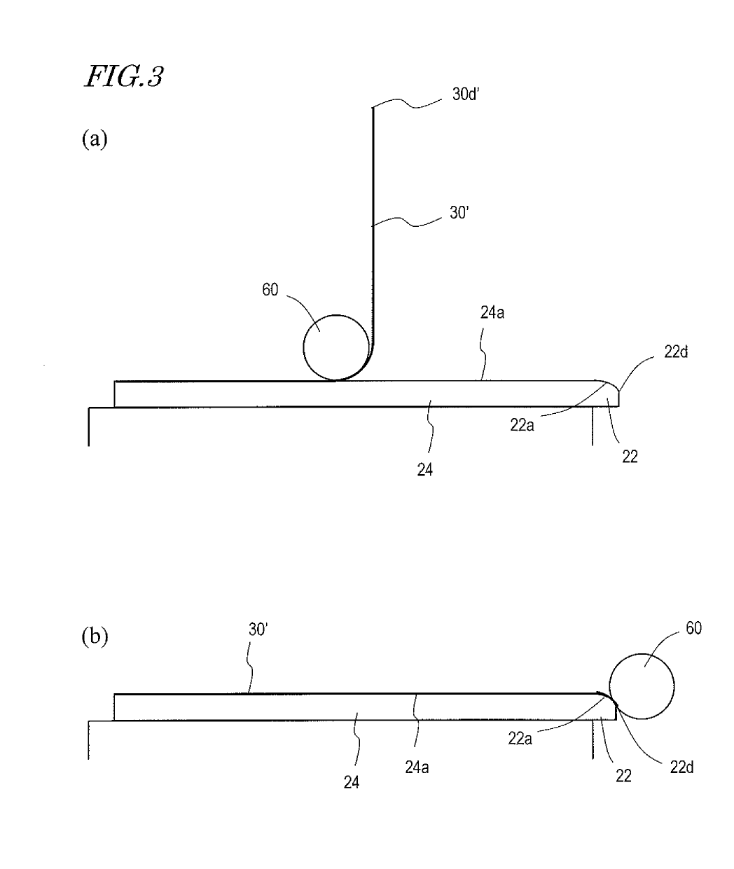

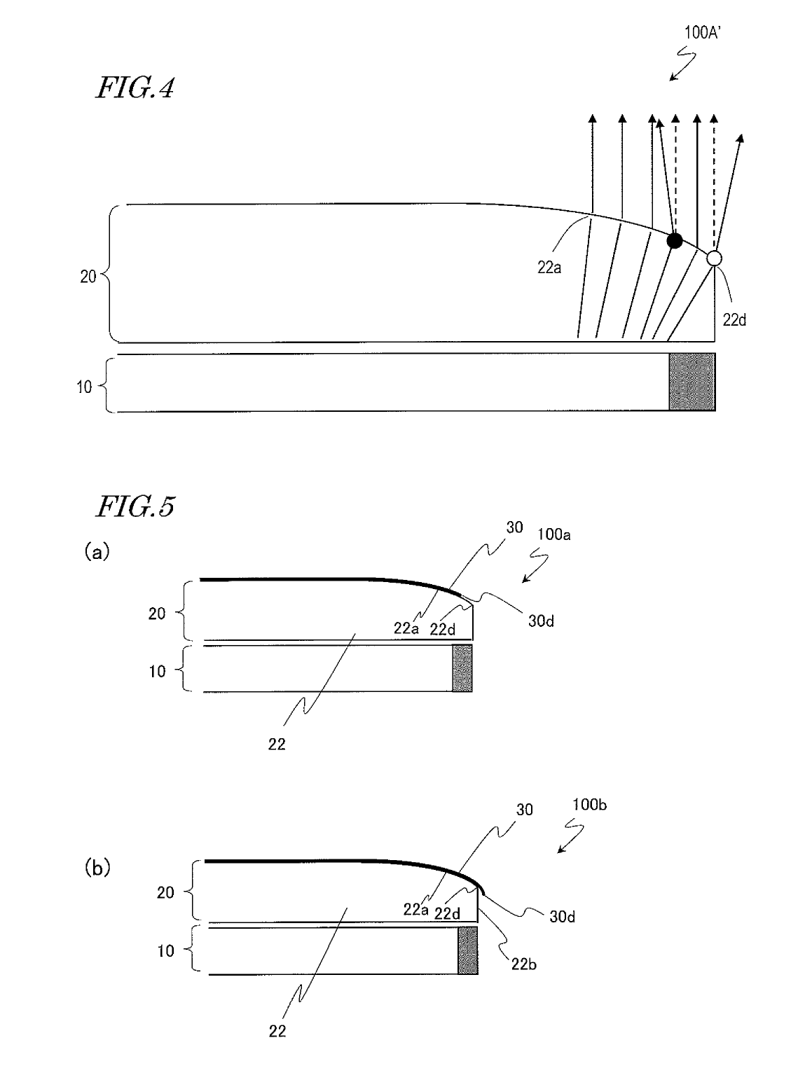

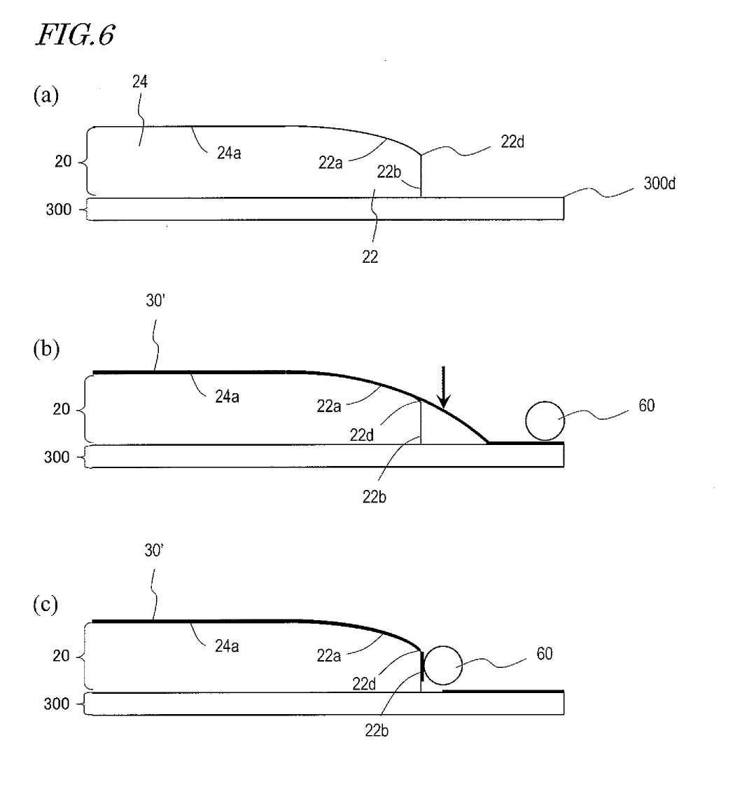

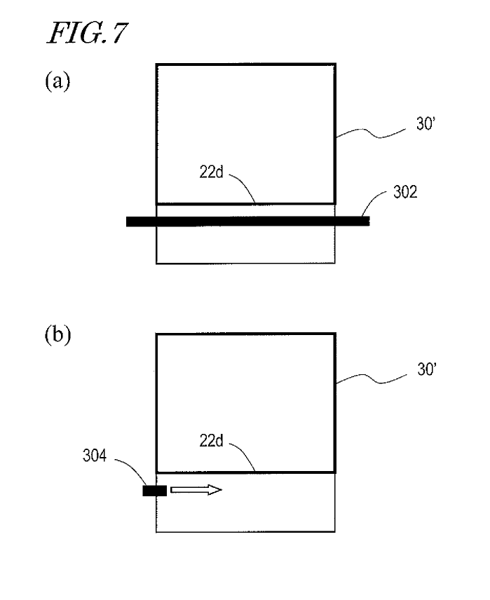

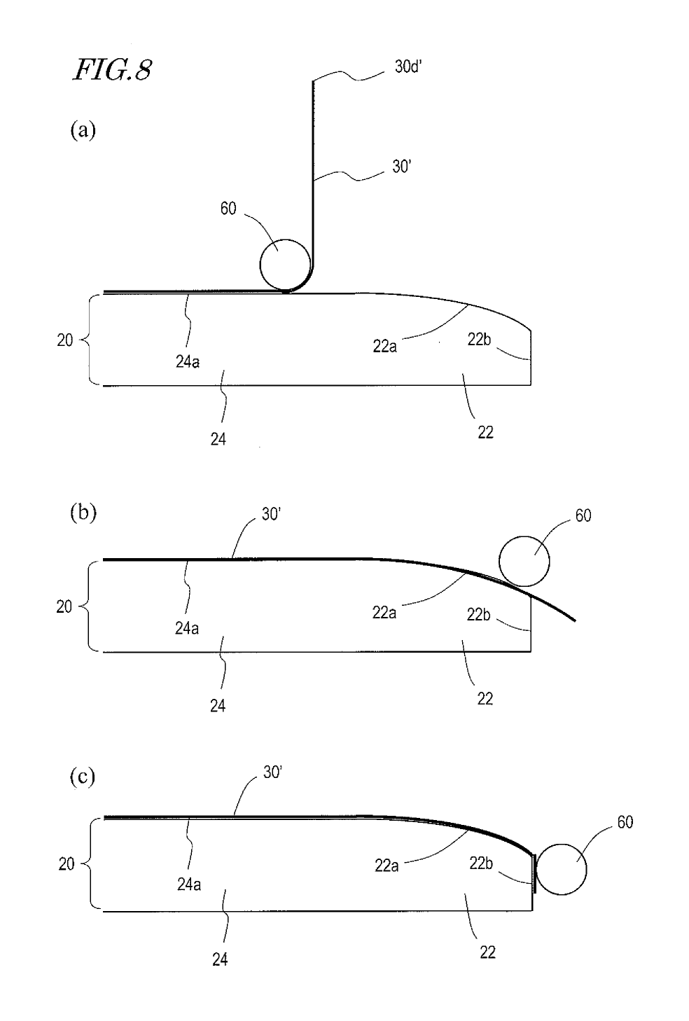

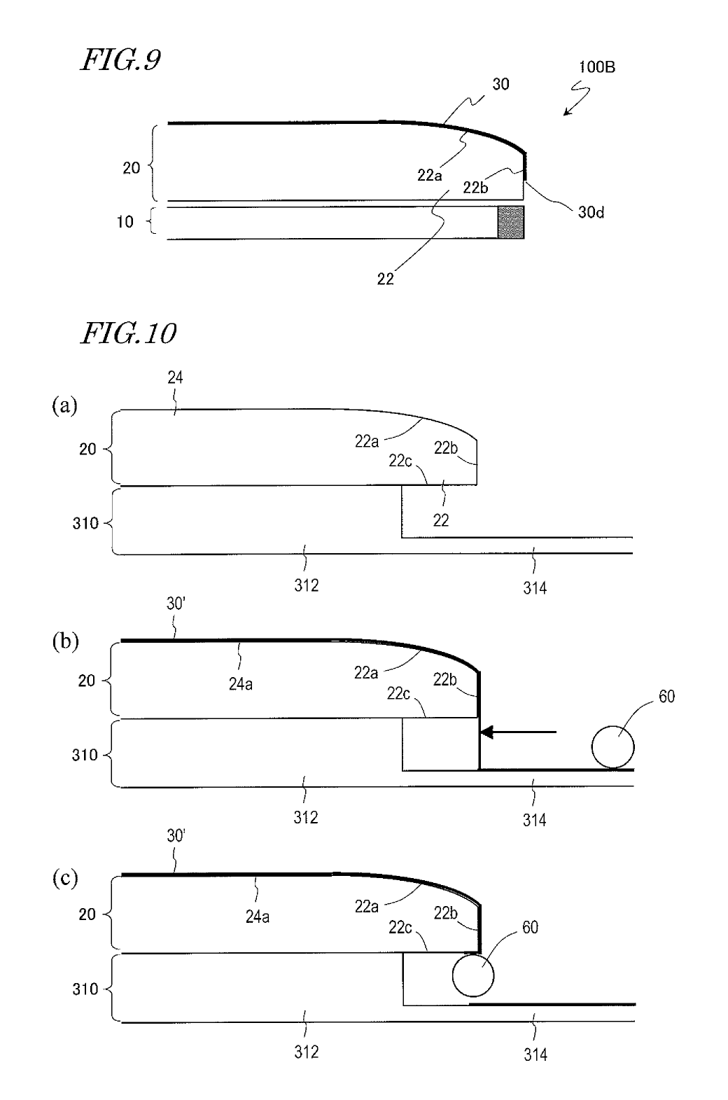

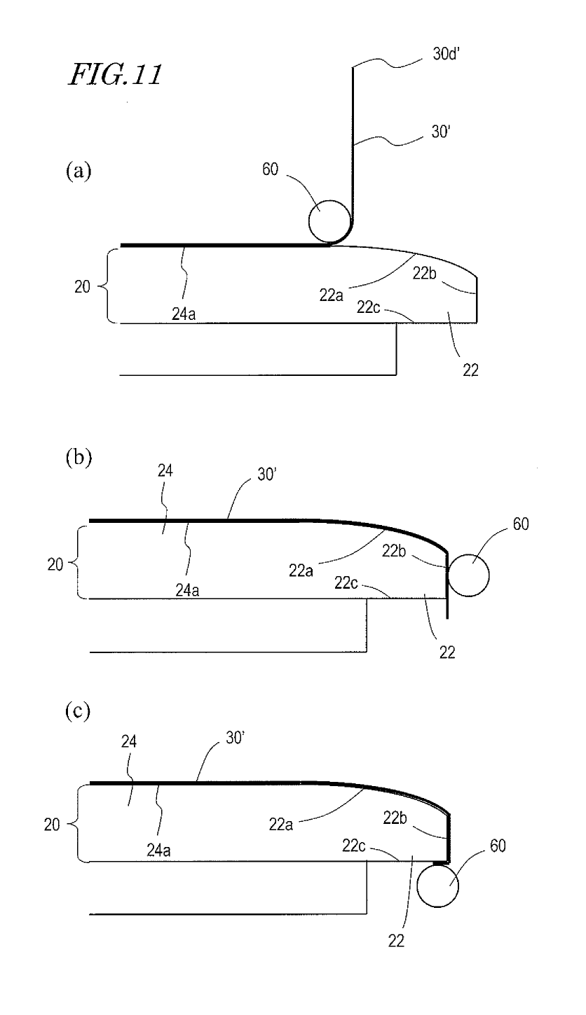

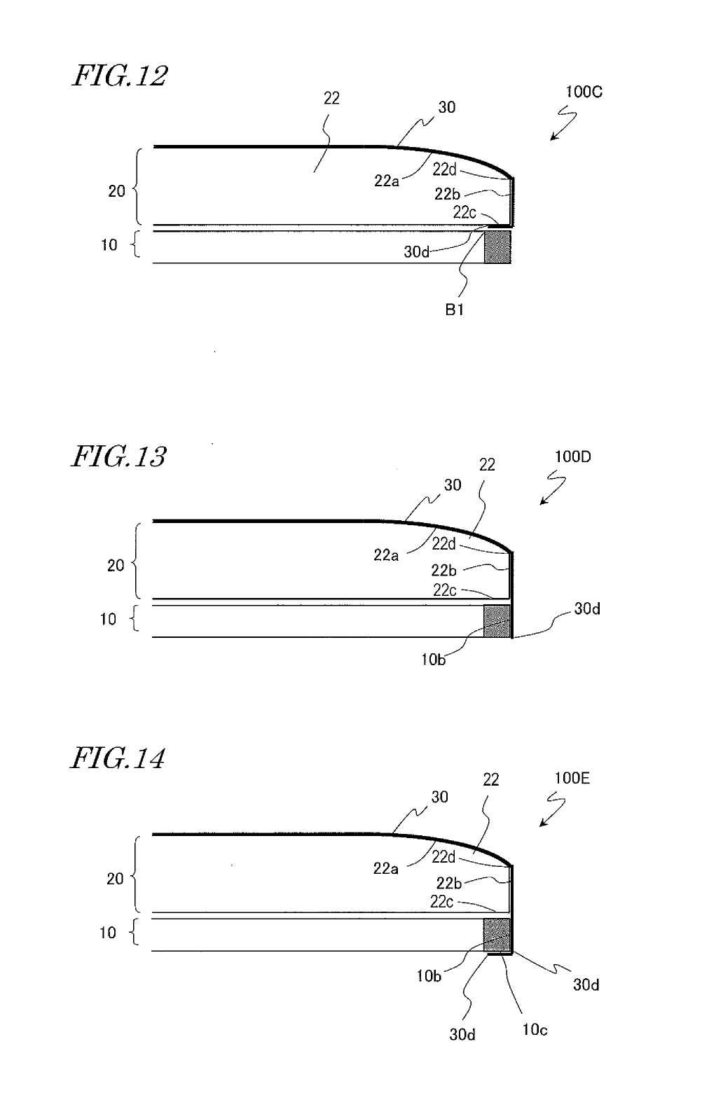

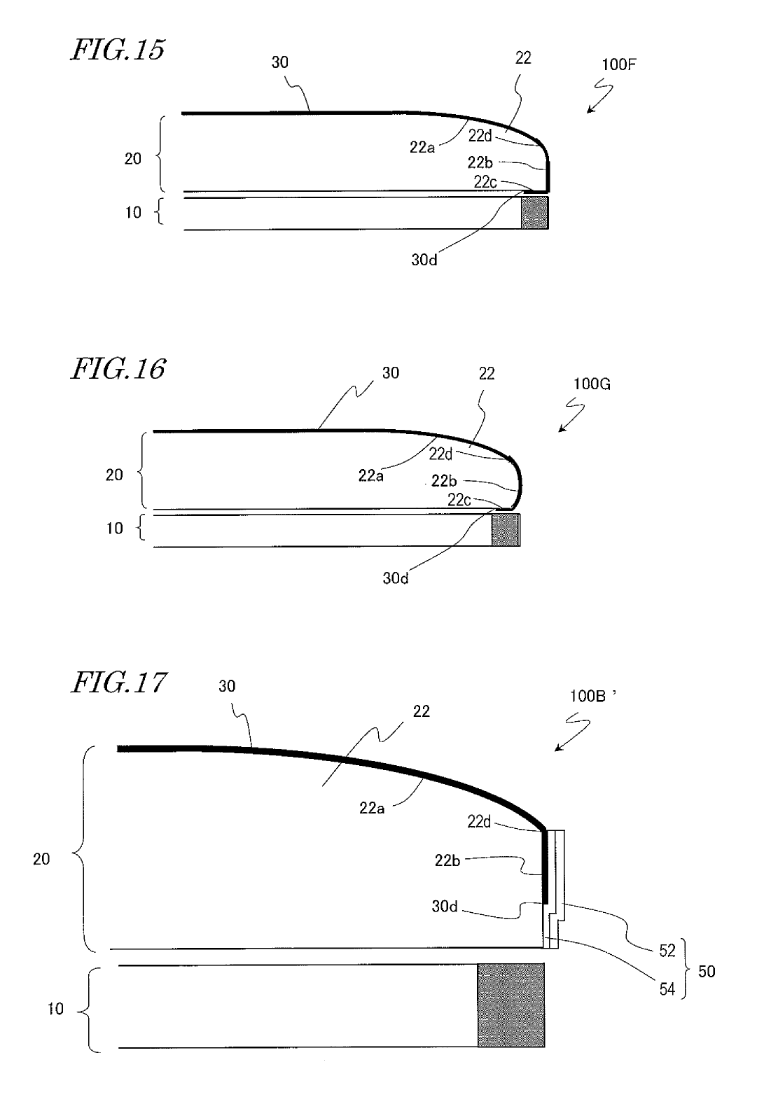

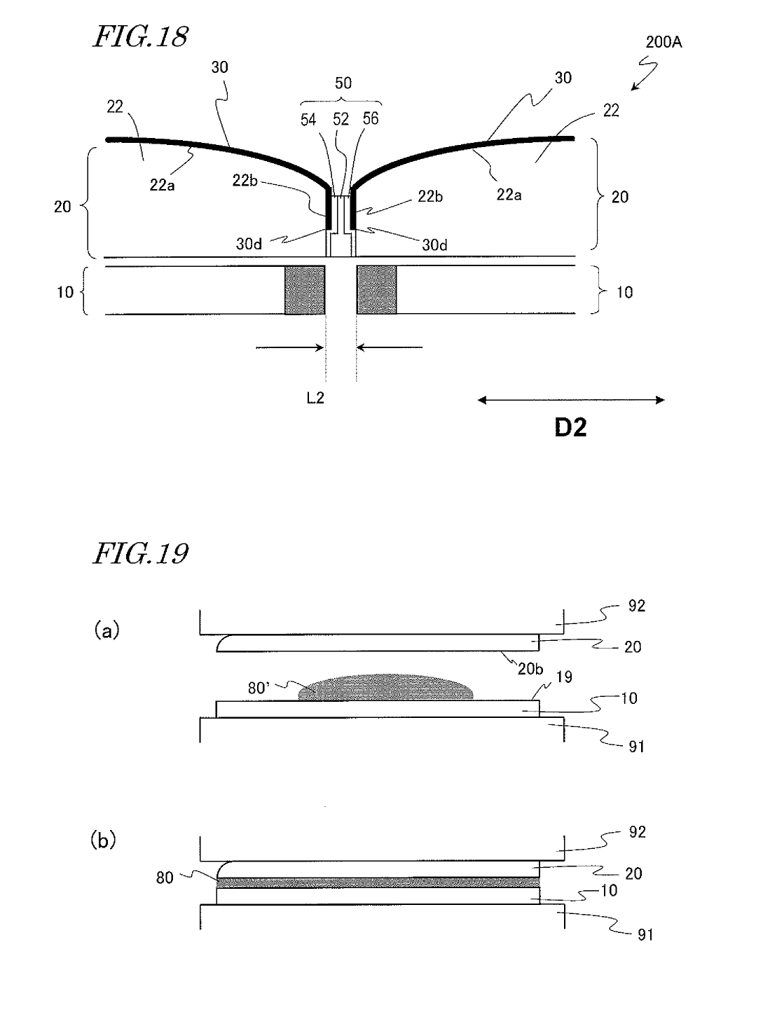

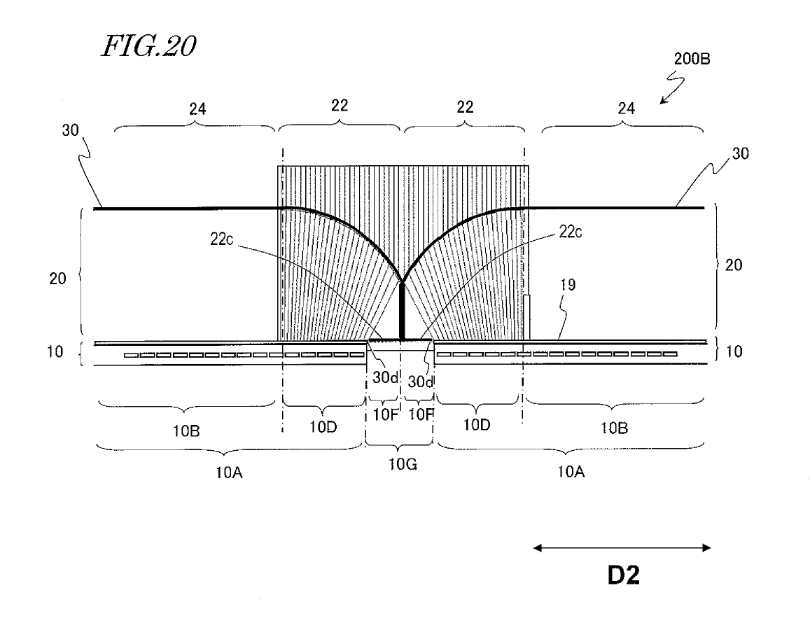

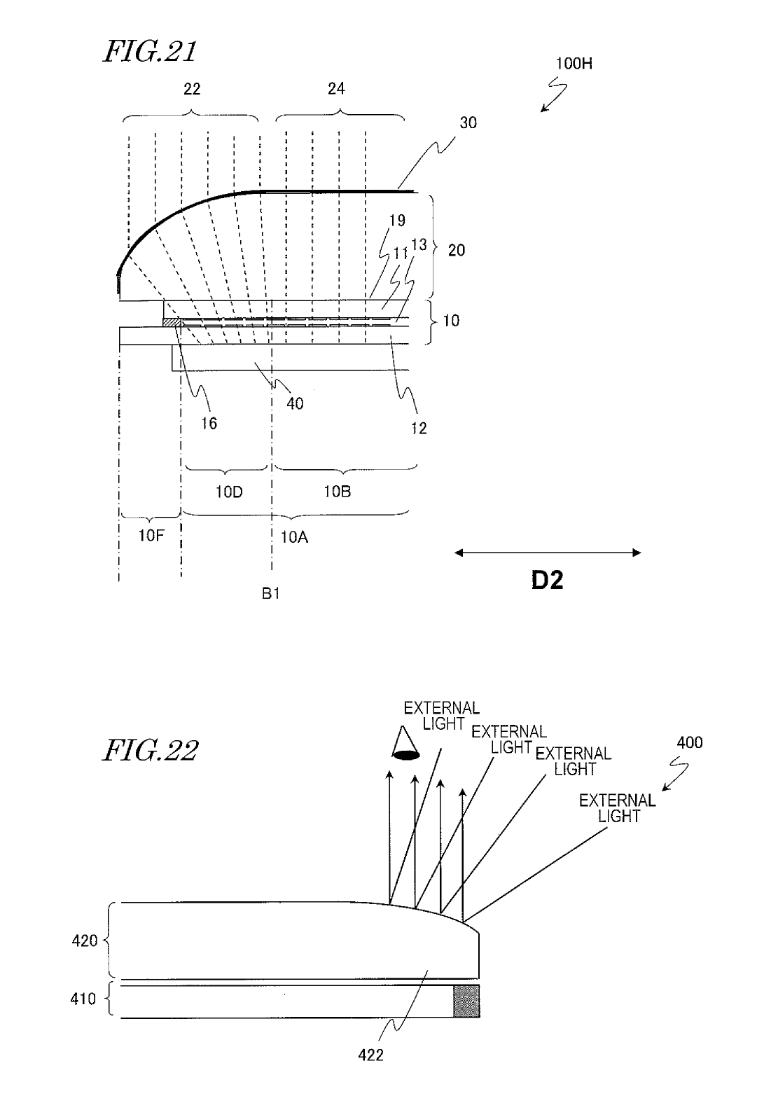

### BRIEF DESCRIPTION OF DRAWINGS

[FIG. 1] A schematic cross-sectional view of a display device 100A which is an embodiment of the present invention.

[FIG. 2] (a) to (d) are schematic cross-sectional views for illustrating a method of fabricating the liquid crystal display device 100A.

[FIGS. 3] (a) and (b) are schematic cross-sectional views for illustrating a method of fabricating the liquid crystal display device 100A.

[FIG. 4] A schematic cross-sectional view of a liquid crystal display device 100A′.

[FIG. 5] (a) is a schematic cross-sectional view of a liquid crystal display device 100a. (b) is a schematic cross-sectional view of a liquid crystal display device 100b.

[FIG. 6] (a) to (c) are schematic cross-sectional views for illustrating a method of fabricating a liquid crystal display device 100B.

[FIGS. 7] (a) and (b) are schematic diagrams for illustrating the direction of movement of a cutting blade.

[FIG. 8] (a) to (c) are schematic cross-sectional views for illustrating a method of fabricating the liquid crystal display device 100B.

[FIG. 9] A schematic cross-sectional view of the liquid crystal display device 100B.

[FIG. 10] (a) to (c) are schematic cross-sectional views for illustrating a method of fabricating a liquid crystal display device 100C.

[FIG. 11] (a) to (c) are schematic cross-sectional views for illustrating a method of fabricating the liquid crystal display device 100C.

[FIG. 12] A schematic cross-sectional view of a liquid crystal display device 100C.

[FIG. 13] A schematic cross-sectional view of a liquid crystal display device 100D.

[FIG. 14] A schematic cross-sectional view of a liquid crystal display device 100E.

[FIG. 15] A schematic cross-sectional view of a liquid crystal display device 100F.

[FIG. 16] A schematic cross-sectional view of a liquid crystal display device 100G.

[FIG. 17] A schematic cross-sectional view of a liquid crystal display device 100B′.

[FIG. 18] A schematic cross-sectional view of a liquid crystal display device 200A.

[FIGS. 19] (a) and (b) are schematic diagrams for illustrating the step of binding a liquid crystal display panel 10 and a light-transmitting cover 20 together.

[FIG. 20] A diagram showing a result of a ray-tracing simulation for a liquid crystal display device 200B.

[FIG. 21] An enlarged schematic cross-sectional view showing part of a liquid crystal display device 100H in the vicinity of a lens portion 22.

[FIG. 22] A schematic cross-sectional view of a display device 400.

### DESCRIPTION OF EMBODIMENTS

Hereinafter, embodiments of the present invention will be described with reference to the drawings. However, the present invention is not limited to the embodiments exemplified below.

FIG. 1 shows a direct-viewing type liquid crystal display device 100A that is an embodiment of the present invention. FIG. 1 is a schematic cross-sectional view of the liquid crystal display device 100A.

As shown in FIG. 1, the liquid crystal display device 100A includes a liquid crystal display panel 10 and a light-transmitting cover 20 provided on the viewer's side of the liquid crystal display panel 10.

The liquid crystal display panel 10 includes a display region 10A and a frame region 10F which is provided outside the display region 10A. There is a boundary B1 between the display region 10A and the frame region 10F. The boundary B1 extends in a direction perpendicular to the sheet of FIG. 1. Hereinafter, the direction in which the boundary B1 extends is sometimes referred to as the first direction D1. The display region 10A includes a central display region 10C and a peripheral display region 10D.

The light-transmitting cover 20 includes a lens portion 22 and a flat portion 24. The lens portion 22 of the light-transmitting cover 20 is disposed astride the boundary B1. The lens portion 22 is configured to refract part of light going out from the display region 10A in the frame region 10F. A light exit surface 22a of the lens portion 22 is a curved surface. The light exit surface 22a is provided with an antireflection treatment. Light going out from the central display region 10C enters the flat portion 24 and travels therethrough.

The peripheral display region 10D of the liquid crystal display panel 10 refers to part of the display region 10A in which the lens portion 22 of the light-transmitting cover 20 is provided at the viewer's side. The flat portion 24 is provided on the central display region 10C. Light going out from the peripheral display region 10D is refracted by the lens portion 22 such that an image formed in the peripheral display region 10D is enlarged so as to be displayed over a region constituted of the peripheral display region 10D and the frame region 10F. Thus, the frame region 10F can be visually obscured.

When the light exit surface is a curved surface, external light coming in from various angles is reflected toward a viewer, so that reflection of the environment is conspicuous, and the display quality deteriorates. In the liquid crystal display device 100A of the present embodiment, the light exit surface 22a of the lens portion 22 is a curved surface and is, however, provided with an antireflection treatment, so that reflection of external light is prevented, and the display quality improves.

In the liquid crystal display device 100A of the present embodiment, the antireflection treatment provided to the light exit surface 22a of the lens portion 22 is attaching an antireflection film 30 as shown in FIG. 1. However, the antireflection treatment is not limited to this example. Specific examples of the antireflection treatment will be described later in detail. As in the liquid crystal display device 100A shown in FIG. 1, the antireflection film 30 may be attached so as to also cover a light exit surface 24a of the flat portion 24 of the light-transmitting cover 20. Note that, in FIG. 1, an adhesion layer or the like for attaching the antireflection film 30 is not shown.

The liquid crystal display panel 10 may be any type of known liquid crystal display panel. Although the liquid crystal display device exemplified in the above embodiment includes a liquid crystal display panel as the display panel, the display panel used in the display device of the embodiments of the present invention is not limited to this example. Examples of the display panel include display panels for PDPs, organic EL display panels, electrophoretic display panels, etc.

Next, a method of fabricating the liquid crystal display device 100A shown in FIG. 1 is described with reference to FIGS. 2(a) to 2(d). FIGS. 2(a) to 2(d) are schematic cross-sectional views for illustrating the method of fabricating the liquid crystal display device 100A.

First, as shown in FIG. 2(a), the light-transmitting cover 20 is provided.

Then, as shown in FIG. 2(b), an antireflection film 30′ is attached with pressure onto the light exit surface 24a of the flat portion 24 via an adhesion layer. As shown in FIG. 2(b), the antireflection film 30′ is attached with pressure being applied by means of a pressure application element 60 that is in the form of a roll. The adhesion layer is formed beforehand over the antireflection film 30, and illustration thereof is omitted herein. The pressure application element 60 that is in the form of a roll is moved in the direction indicated by the arrow.

Then, as shown in FIG. 2(c), the antireflection film 30′ is attached with pressure onto the light exit surface 22a of the lens portion 22.

Then, as shown in FIG. 2(d), the antireflection film 30′ is cut off at the edge 22d of the lens portion 22. Here, the edge 22d of the lens portion 22 refers to a portion where the light exit surface 22a and the side surface 22b intersect with each other. The cut-off position is indicated by the arrow in FIG. 2(d).

Then, for example, the liquid crystal display panel 10 is located on the rear surface of the light-transmitting cover 20, and these elements are combined together via an adhesive agent, whereby the liquid crystal display device 100A shown in FIG. 1 is obtained. Specific examples of the method of combining the light-transmitting cover 20 and the liquid crystal display panel 10 together will be described later.

In the above-described example of the fabrication method, the antireflection film 30 is attached onto the light exit surface 22a of the lens portion 22 before the light-transmitting cover 20 and the liquid crystal display panel 10 are combined together. However, for example, it may be possible that, firstly, a display panel unit which includes the liquid crystal display panel 10 and the light-transmitting cover 20 is provided, and then, an antireflection film is attached and cur off. In FIG. 2(b), the pressure application element 60 that is in the form of a roll is moved, whereby the antireflection film 30′ is attached onto the light-transmitting cover 20. However, the light-transmitting cover 20 may be moved for attaching the antireflection film 30′. In other words, the pressure application element 60 that is in the form of a roll is moved relative to the light-transmitting cover 20, whereby the antireflection film 30′ is attached onto the light-transmitting cover 20.

In the above-described step of cutting the antireflection film 30′, for example, a rotary cutter is used as the cutting blade. Specific examples of the direction of the movement of the cutting blade will be described later.

In the above-described fabrication method, the antireflection film 30′ is cut off after having been attached onto the light exit surface 22a of the lens portion 22. However, the antireflection film 30′ may be attached onto the light exit surface 22a after having been cut off. In this case, the fabrication method is specifically as described below, which will be described with reference to FIGS. 3(a) and 3(b).

First, the antireflection film 30′ is cut off so as to have an adjusted length such that, after having been attached, the position of the edge 30d of the antireflection film 30 would be coincident with the edge 22d of the lens portion 22 (the cut-off position is indicated by 30d′ in FIG. 3(a)). The resultant antireflection film 30′ is attached with pressure onto the light exit surface 24a of the flat portion 24 as shown in FIG. 3(a).

Then, as shown in FIG. 3(b), the antireflection film 30′ is attached with pressure onto the light exit surface 24a of the flat portion 24 and the light exit surface 22a of the lens portion 22.

Then, the light-transmitting cover 20 and the liquid crystal display panel 10 are combined together in a way similar to the fabrication method previously described with reference to FIG. 2, whereby the liquid crystal display device 100A shown in FIG. 1 is obtained.

According to the fabrication method previously described with reference to FIG. 2, the antireflection film 30′ is cut off at the edge 22d of the lens portion 22, and therefore, the edge 22d of the lens portion 22 may sometimes have a cut scar. If the edge 22d has a cut scar, the display quality deteriorates as described below.

Why a cut scar leads to deterioration of the display quality is described with reference to FIG. 4. FIG. 4 is a schematic cross-sectional view of a liquid crystal display device 100A′ which has a cut scar. In FIG. 4, arrows represent light rays going out from the edge 22d in the case where the edge 22d of the lens portion (which is indicated by an open circle in FIG. 4) has a cut scar. Although light rays going out from the lens portion 22 preferably travel straight toward a viewer in a direction perpendicular to the display surface 10a of the display panel, a light ray going out from the edge 22d (which is indicated by a solid-line arrow) would not be emitted in a desired direction (which is indicated by a broken-line arrow) due to irregularities caused by the cut scar as shown in FIG. 4. Therefore, display unevenness occurs across the light exit surface 22a of the lens portion 22.

If the positioning accuracy of the cut-off position of the antireflection film 30′ is poor, the display quality may sometimes deteriorate as described hereinbelow. If the positioning accuracy of the cut-off position of the antireflection film 30′ is poor, the edge 30d of the antireflection film 30 is present at an inner or outer position relative to the edge 22d of the lens portion 22. When the antireflection film 30′ is cut off at an inner position relative to the edge 22d of the lens portion 22, the light exit surface 22a may have a cut scar. If the light exit surface 22a of the lens portion 22 has a cut scar (the position of occurrence of the cut scar in the light exit surface 22 is indicated by a solid circle), an outgoing light ray does not travel in a desired direction, as in the case where the edge 22d has a cut scar, so that display unevenness occurs.

Due to an external force caused by cutting of the antireflection film 30′, part of the antireflection film 30′ may sometimes peel off from the lens portion 22. With a peeled portion, air intervenes between the antireflection film 30 and the light exit surface 22a so that the antireflection effect deteriorates. In the case where the antireflection film 30′ is cut off on the edge 22d or the light exit surface 22a of the lens portion 22, the cut section may have a roughened surface. In this case, the antireflection effect also deteriorates.

When attaching an antireflection film which has been cut off beforehand in a way similar to the fabrication method previously described with reference to FIG. 3, poor positioning accuracy of the cut-off position would result in that the cut-off position is at an inner or outer position relative to the edge 22d of the lens portion 22. If the cut-off position lies at an inner position relative to the edge 22d of the lens portion 22, display unevenness would sometimes occur. If the cut-off position lies at an outer position relative to the edge 22d of the lens portion 22, the antireflection film would readily peel off. This fact will be described hereinbelow with reference to FIGS. 5(a) and 5(b).

FIG. 5(a) is a schematic cross-sectional view of a liquid crystal display device 100a in which the cut-off position is at an inner position relative to the edge 22d of the lens portion 22. When the cut-off position is at an inner position relative to the edge 22d of the lens portion 22, part of the light exit surface 22a of the lens portion 22 is not provided with the antireflection film 30. In the other part of the light exit surface 22a of the lens portion which is provided with the antireflection film 30, reflection of external light is prevented, while the part of the light exit surface 22a which is not provided with the antireflection film 30 readily reflects external light. Therefore, when the cut-off position is at an inner position relative to the edge 22d of the lens portion 22, display unevenness would occur.

FIG. 5(b) is a schematic cross-sectional view of a liquid crystal display device 100b in which the cut-off position is at an outer position relative to the edge 22d of the lens portion 22. As shown in FIG. 5(b), in the liquid crystal display device 100b, part of the antireflection film 30 extends beyond the edge 22d of the lens portion 22. When the antireflection film 30 has such a surplus part, external force is readily exerted on the surplus part of the antireflection film in the assembly step, so that the antireflection film 30 can readily peel off. Even when the surplus part of the antireflection film 30 is attached onto the side surface 22b of the lens portion 22, the antireflection film 30 can readily peel off due to the rigidity of the antireflection film itself because the surplus part of the antireflection film 30 is attributed to poor positioning accuracy relative to the edge 22d of the lens portion 22, and part of the antireflection film 30 extending over the side surface 22b is short so that the area of the antireflection film 30 attached onto the side surface 22b is small.

Thus, when the antireflection film 30′ is cut off beforehand in a way similar to the fabrication method previously described with reference to FIG. 3, it is preferred that the antireflection film is cut off such that the positioning accuracy relative to the edge 22d of the lens portion 22 improves. If the positioning accuracy is poor, an undesirable display device, such as the liquid crystal display device 100a (FIG. 5(a)) or the liquid crystal display device 100b (FIG. 5(b)), would be obtained. Therefore, the manufacturing yield is low. When the antireflection film 30′ is attached after having been cut off in a way similar to the fabrication method previously described with reference to FIG. 3, a cut scar and peeling off of the film in the cutting step, which would occur in the fabrication method previously described with reference to FIG. 2, would not occur. However, as described above, poor positioning accuracy disadvantageously leads to low manufacturing yield.

When the antireflection film 30′ is cut off after having been attached as previously described with reference to FIG. 4 (FIG. 2), the positioning accuracy of the cut-off position is poor. If the antireflection film 30′ is cut off at a position on the light exit surface 22a to produce a cut scar in the light exit surface 22a, light would not be emitted in a desired direction due to irregularities caused by the cut scar, so that display unevenness occurs. Here, absence of the antireflection film 30 in part of the light exit surface 22a also causes display unevenness by the same mechanism as in the liquid crystal display device 100a (FIG. 5(a)). In the case where the antireflection film 30′ is cut off after having been attached, if the accuracy of the cut-off position is poor so that part of the antireflection film 30 extends beyond the edge 22d of the lens portion 22, the antireflection film would readily peel off by the same mechanism as in the liquid crystal display device 100b (FIG. 5(b)). Therefore, even when the antireflection film 30′ is cut off after having been attached, the cutting is preferably performed with high positioning accuracy.

In a liquid crystal display device which is obtained according to a fabrication method which will be described below (a liquid crystal display device 100B shown in FIG. 9, which will be described later), an edge of the antireflection film is present on a side surface of the lens portion, and therefore, occurrence of display unevenness and peeling which have been previously described are prevented. The fabrication method of this liquid crystal display device is described hereinafter with reference to FIGS. 6(a) to 6(c). FIGS. 6(a) to 6(c) are schematic cross-sectional views for illustrating the fabrication method of the liquid crystal display device 100B (FIG. 9).

First, as shown in FIG. 6(a), a supporting plate 300 and the light-transmitting cover 20 are provided. Here, the light-transmitting cover 20 is placed on the supporting plate 300 such that an edge 300d of the supporting plate 300 is located at an outer position relative to the edge 22d of the lens portion 22.

Then, as shown in FIG. 6(b), the antireflection film 30′ is attached with pressure onto the light exit surface 24a of the flat portion 24 and the light exit surface 22a of the lens portion 22 of the light-transmitting cover 20 and the supporting plate 300 via an adhesion layer. Here, the antireflection film 30′ is attached such that part of the attached antireflection film 30′ extending between the edge 22d and the supporting plate 300 is not in contact with the light-transmitting cover 20 or the supporting plate 300. Thereafter, the antireflection film 30′ is cut off at a position indicated by the arrow in FIG. 6(b) so as to have an adjusted length such that, after having been cut off, the edge 30d of the antireflection film 30 is on the side surface 22b of the lens portion 22.

Then, as shown in FIG. 6(c), the antireflection film 30′ is attached onto the side surface 22b of the lens portion 22 with pressure being applied by means of the pressure application element 60 that is in the form of a roll.

Then, for example, the liquid crystal display panel 10 is placed on the rear surface of the light-transmitting cover 20, and these elements are combined together by means of an adhesive agent, whereby the liquid crystal display device 100B shown in FIG. 9 is obtained.

In the example described above for the fabrication method, the light-transmitting cover 20 and the liquid crystal display panel 10 are combined together after the antireflection film 30 has been attached onto the light exit surface 22a and the side surface 22b of the lens portion 22. For example, it may be possible that, firstly, a display panel unit which includes the liquid crystal display panel 10 and the light-transmitting cover 20 is provided, and then, an antireflection film is attached and cut off.

The direction of movement of the cutting blade in the cutting step which is illustrated in FIG. 6(b) is described with reference to FIGS. 7(a) and 7(b). FIGS. 7(a) and 7(b) are diagrams for illustrating the cutting step, which are schematic top views of the light-transmitting cover 20. As shown in FIG. 7(a), when the antireflection film 30′ is cut off using a cutting blade 302 which is longer than the width of the antireflection film 30′, the cutting blade 302 may be descended toward the supporting plate 300 (in a direction perpendicular to the sheet of FIG. 7(a)) for cutting the antireflection film 30′. Alternatively, for example, when a cutting blade such as the aforementioned rotary cutter or the like is used, the antireflection film 30′ may be cut off by moving the cutting blade 304 in a direction perpendicular to the longitudinal direction of the antireflection film 30′ as shown in FIG. 7(b). In FIG. 7(b), the arrow indicates the direction of movement of the cutting blade 304.

In the above-described example of the fabrication method (FIGS. 6(a) to 6(c)), the antireflection film 30′ is cut off after having been attached onto the lens portion 22. However, the antireflection film 30′ may be cut off before it is attached. A fabrication method employed in this case will be described below with reference to FIGS. 8(a) and 8(b).

First, the antireflection film 30′ is cut off so as to have an adjusted length such that, after having been cut off, the edge 30d of the antireflection film 30 is on the side surface 22b of the lens portion 22. The cut-off position is indicated by 30d′ in FIG. 8(a). The resultant antireflection film 30′ is attached with pressure onto the light exit surface 24a of the flat portion 24 as shown in FIG. 8(a).

Then, as shown in FIG. 8(b), the antireflection film 30′ is attached with pressure onto the light exit surface 24a of the flat portion 24 and the light exit surface 22a of the lens portion 22.

Then, as shown in FIG. 8(c), the antireflection film 30′ is attached with pressure onto the side surface 22b of the lens portion 22.

Then, the light-transmitting cover 20 and the liquid crystal display panel 10 are combined together, whereby the liquid crystal display device 100B (FIG. 9) is obtained.

FIG. 9 schematically shows a cross sectional structure of the liquid crystal display device 100B obtained according to the fabrication method which has been previously described with reference to FIG. 6 and FIG. 8. As shown in FIG. 9, an edge 30d of the antireflection film 30 is on the side surface 22b of the lens portion 22. Here, the light exit surface 22a is entirely covered with the antireflection film 30, display unevenness which would occur in the liquid crystal display device 100A′ as previously described with reference to FIG. 4 does not occur. In the liquid crystal display device 100B shown in FIG. 9, part of the antireflection film 30 does not extend beyond the edge 22d of the lens portion 22 as in the liquid crystal display device 100b (FIG. 5(b)) and therefore hardly peels off.

As previously described with reference to FIG. 5(b), even when the surplus part of the antireflection film 30 is attached onto the side surface 22b of the lens portion 22, the surplus part can readily peel off because it is short. On the other hand, as shown in FIG. 9, when the antireflection film 30 is cut off such that the edge 30d of the antireflection film 30 is present on the side surface 22b of the lens portion 22, the area of part of the antireflection film 30 which is adhered onto the side surface 22b of the lens portion 22 is relatively large, so that the antireflection film 30 hardly peels off. The area which enables obtaining a sufficient adhesion force may be appropriately determined with consideration for the rigidity of the antireflection film 30. Note that the adhesive agent used herein (including a pressure sensitive adhesive) preferably has an adhesion force of not less than 7 N/20 mm.

According to the fabrication method which has previously been described with reference to FIG. 6 and FIG. 8, a cut scar and peeling off of the film in the cutting step as in the display device 100A′ (FIG. 4) would not occur. Therefore, deterioration of the display quality due to a cut scar and peeling off of the film in the cutting step would not occur.

According to the fabrication method which has previously been described with reference to FIG. 8, the cut-off position is adjusted such that the edge 30d of the antireflection film 30 is present on the side surface 22b of the lens portion 22. In this step, the accuracy of the cut-off position may be lower than that required by the fabrication method previously described with reference to FIG. 3 in which the antireflection film is cut off such that the edge 30d of the antireflection film 30 is coincident with the edge 22d of the lens portion 22.

Thus, by employing the fabrication method which has previously been described with reference to FIG. 6 and FIG. 8, the liquid crystal display device 100B (FIG. 9) can be obtained in which occurrence of display unevenness and peeling off of the antireflection film 30 are prevented.

Next, a liquid crystal display device of another embodiment of the present invention (a liquid crystal display device 100C shown in FIG. 12) is described. A fabrication method of the liquid crystal display device 100C is described with reference to FIGS. 10(a) to 10(c). FIGS. 10(a) to 10(c) are schematic cross-sectional views for illustrating the fabrication method of the liquid crystal display device 100C (FIG. 12).

First, as shown in FIG. 10(a), a supporting plate 310 and the light-transmitting cover 20 are provided. As shown in FIG. 10(a), the supporting plate 310 includes a base portion 312 and a protruding portion 314. The light-transmitting cover 20 is placed on the supporting plate 310 such that part of the rear surface 22c of the lens portion 22 extends beyond the base portion 312 of the supporting plate 310 so as to be present above the protruding portion 314.

Then, as shown in FIG. 10(b), the antireflection film 30′ is attached with pressure onto the light exit surface 24a of the flat portion 24 and the light exit surface 22a and the side surface 22b of the lens portion 22 of the light-transmitting cover 20 and onto the protruding portion 314 of the supporting plate 310 via an adhesion layer. Thereafter, the antireflection film 30′ is cut off at a position indicated by the arrow in FIG. 10(b) such that, after having been cut off, the edge 30d of the antireflection film 30 is on the rear surface 22c of the lens portion 22.

Then, as shown in FIG. 10(c), the antireflection film 30′ is turned up and attached onto the rear surface 22c of the lens portion 22 with pressure being applied by means of the pressure application element 60 that is in the form of a roll.

Then, for example, the liquid crystal display panel 10 is placed on the rear surface of the light-transmitting cover 20, and these elements are combined together by means of an adhesive agent, whereby the liquid crystal display device 100C shown in FIG. 12 is obtained.

In the above-described example of the fabrication method, the antireflection film 30′ is cut off after having been attached onto the light exit surface 22a and the side surface 22b of the lens portion 22. However, the antireflection film 30′ may be cut off before it is attached. A fabrication method employed in this case will be described below with reference to FIGS. 11(a) to 11(c).

First, the antireflection film 30′ is cut off so as to have an adjusted length such that, after having been cut off, the edge 30d of the antireflection film 30 is on the rear surface 22c of the lens portion 22. The cut-off position is indicated by 30d′ in FIG. 11(a). The resultant antireflection film 30′ is attached with pressure onto the light exit surface 24a of the flat portion 24 as shown in FIG. 11(a).

Then, as shown in FIG. 11(b), the antireflection film 30′ is attached with pressure onto the light exit surface 24a of the flat portion 24 and the light exit surface 22a and the side surface 22b of the lens portion 22.

Then, as shown in FIG. 11(c), the antireflection film 30′ is attached with pressure onto the rear surface 22c.

Then, the light-transmitting cover 20 and the liquid crystal display panel 10 are combined together, whereby the liquid crystal display device 100C (FIG. 12) is obtained.

FIG. 12 schematically shows a cross sectional structure of the liquid crystal display device 100C obtained according to the above-described fabrication method. As shown in FIG. 12, the edge 30d of the antireflection film 30 is on the rear surface 22c of the lens portion 22.

In the liquid crystal display device 100C shown in FIG. 12, occurrence of display unevenness and peeling off of the antireflection film 30 are prevented as in the liquid crystal display device 100B shown in FIG. 9. Also, in the liquid crystal display device 100C, the antireflection film is also attached on the rear surface 22c of the lens portion 22, and therefore, advantageously, the antireflection film 30 is more effectively prevented from peeling off as compared to the liquid crystal display device 100B.

Since according to the display device fabrication method illustrated in FIG. 10 the antireflection film 30′ is cut off at a position different from the edge 22d or the light exit surface 22a of the lens portion 22 as shown in FIG. 10(a), this method is advantageous in that peeling off and a cut scar, which may occur in the cutting step in the fabrication method illustrated in FIG. 2, would not occur. According to the fabrication method illustrated in FIG. 11, likewise as in the case of the fabrication method illustrated in FIG. 8, the accuracy of the cut-off position of the antireflection film 30 may be lower than that required by the fabrication method illustrated in FIG. 3. Note that the fabrication method illustrated in FIG. 2 is advantageous in that the step of turning up and attaching the antireflection film which have been described with reference to FIGS. 11(a) and 11(b) are unnecessary.

In the liquid crystal display device 100C (FIG. 12), it is preferred that the edge 30d of the antireflection film 30 is on the frame region side of the boundary lying between the display region and the frame region (which is designated by B1 in FIG. 1), i.e., on the right side of the boundary B1 in FIG. 12. Because part of the antireflection film 30 extending over the rear surface 22c of the lens portion 22 does not affect displaying.

Next, a liquid crystal display device which is another embodiment of the present invention (a liquid crystal display device 100D shown in FIG. 13) is described. The liquid crystal display device 100D is obtained by cutting off the antireflection film such that, after having been cut off, the position of the edge 30d of the antireflection film 30 is on the side surface 10b of the liquid crystal display panel 10. Specifically, for example, firstly, a display panel unit which includes the liquid crystal display panel 10 and the light-transmitting cover 20 is provided. Thereafter, in the same way as illustrated in FIGS. 2(a) to 2(c) and FIG. 11(b), for example, the antireflection film 30′ is attached onto the light exit surface 24a of the flat portion 24, the light exit surface 22a of the lens portion 22, and the side surface 22b of the lens portion 22. Then, the antireflection film 30′ is attached onto the side surface 10b of the liquid crystal display panel 10, and the antireflection film 30′ is cut off, whereby the liquid crystal display device 100D shown in FIG. 13 is obtained. Here, the antireflection film 30′ is cut off such that, after having been cut off, the edge 30d of the antireflection film 30 is present on the side surface 10b of the liquid crystal display panel 10.

FIG. 13 schematically shows a cross sectional structure of the liquid crystal display device 100D obtained as described above. As shown in FIG. 13, the edge 30d of the antireflection film 30 is on the side surface 10b of the liquid crystal display panel 10. In the liquid crystal display device 100D shown in FIG. 13, occurrence of peeling off of the antireflection film 30 and display unevenness are prevented as in the liquid crystal display device 100B (FIG. 9) and the liquid crystal display device 100C (FIG. 12). Also, the liquid crystal display device 100D is advantageous in that occurrence of a cut scar and peeling off in the cutting step are prevented.

Next, a liquid crystal display device which is another embodiment of the present invention (a liquid crystal display device 100E shown in FIG. 14) is described. The liquid crystal display device 100E is obtained by cutting off the antireflection film such that, after having been cut off, the position of the edge 30d of the antireflection film 30 is on the rear surface 10c of the liquid crystal display panel 10. Specifically, for example, firstly, a display panel unit which includes the liquid crystal display panel 10 and the light-transmitting cover 20 is provided. Thereafter, in the same way as illustrated in FIGS. 2(a) to 2(c) and FIG. 11(b), for example, the antireflection film 30′ is attached onto the light exit surface 24a of the flat portion 24, the light exit surface 22a of the lens portion 22, and the side surface 22b of the lens portion 22. Then, the antireflection film 30′ is attached onto the side surface 10b of the liquid crystal display panel 10, and the antireflection film 30′ is attached onto the rear surface 10c of the liquid crystal display panel 10. Thereafter, the antireflection film 30′ is cut off, whereby the liquid crystal display device 100E shown in FIG. 14 is obtained. Here, the antireflection film 30′ is cut off so as to have an adjusted length such that, after having been cut off, the edge 30d of the antireflection film 30 is present on the rear surface 10c of the liquid crystal display panel 10.

FIG. 14 schematically shows a cross sectional structure of the liquid crystal display device 100E obtained as described above. As shown in FIG. 14, the edge 30d of the antireflection film 30 is on the rear surface 10c of the liquid crystal display panel 10. In the liquid crystal display device 100E shown in FIG. 14, occurrence of peeling off of the antireflection film 30 and display unevenness are prevented as in the liquid crystal display device 100B (FIG. 9), the liquid crystal display device 100C (FIG. 12), and the liquid crystal display device 100D (FIG. 13). Also, the liquid crystal display device 100E is advantageous in that occurrence of a cut scar and peeling off in the cutting step are prevented.

In the above-described liquid crystal display device 100D (FIG. 13), the antireflection film 30′ may be cut off before being attached, so as to have an adjusted length such that, after having been attached, the edge 30d of the antireflection film 30 is on the side surface 10b of the liquid crystal display panel 10, rather than cutting off the antireflection film 30′ after having been attached onto the light exit surface 22a of the lens portion 22, the side surface 22b of the lens portion 22, and the side surface 10b of the liquid crystal display panel 10. This example is preferred because a cut scar is not formed in the side surface 10b of the liquid crystal display panel 10. This also applies to the liquid crystal display device 100E (FIG. 14). If the antireflection film 30′ is cut off beforehand so as to have an adjusted length such that, after having been attached, the edge 30d of the antireflection film 30 is on the rear surface 10c of the liquid crystal display panel 10, a cut scar would not formed in the rear surface 10c. Note that, a cut scar formed in the side surface 10b of the rear surface 10c of the liquid crystal display panel 10 can be a cause of a crack in the liquid crystal display panel 10.

When the antireflection film 30 is attached onto the light exit surface 22a and the side surface 22b of the lens portion 22 as in the liquid crystal display devices 100B (FIG. 9), 100C (FIG. 12), 100D (FIGS. 13) and 100E (FIG. 14), a corner of the lens portion 22 at which the light exit surface 22a and the side surface 22b meet each other (i.e., in the vicinity of the edge 22d of the lens portion 22) may have a curved surface (FIG. 15). In the liquid crystal display device 100F shown in FIG. 15, the edge 30d of the antireflection film 30 is on the rear surface 22c of the lens portion 22. A corner of the liquid crystal display device 100F at which the light exit surface 22a and the side surface 22b of the lens portion 22 meet each other has a curved surface. When the surface is formed by a curved surface in the vicinity of the edge 22d of the lens portion 22, the antireflection film 30 is more effectively prevented from peeling off.

When the antireflection film 30 is attached onto the rear surface 22c of the lens portion 22 as in the liquid crystal display device 100C shown in FIG. 12, it is more preferred that the corner at which the side surface 22b and the rear surface 22c of the lens portion 22 meet each other is formed by a curved surface. FIG. 16 shows a schematic cross-sectional view of a liquid crystal display device 100G which has such a configuration. In the liquid crystal display device 100G shown in FIG. 16, the edge 30d of the antireflection film 30 is on the rear surface 22c of the lens portion 22. A corner of the liquid crystal display device 100G at which the light exit surface 22a and the side surface 22b of the lens portion 22 meet each other has a curved surface, and another corner of the liquid crystal display device 100G at which the side surface 22b and the rear surface 22c of the lens portion 22 meet each other also has a curved surface. When the corner at which the side surface 22b and the rear surface 22c of the lens portion 22 meet each other also has a curved surface, the antireflection film 30 is more effectively prevented from peeling off.

A liquid crystal display device in which the edge 30d of the antireflection film 30 is on the side surface 22b of the lens portion 22 as in the liquid crystal display device 100B shown in FIG. 9 may further include a protection tape 50. The protection tape 50 includes a support layer 52 and an adhesion layer 54 which is provided on one surface of the support layer 52. The protection tape 50 may be attached so as to cover the edge 30d and the side surface 22b of the lens portion 22 (FIG. 17). In the liquid crystal display device 100B′ shown in FIG. 17, the protection tape 50 is attached so as to cover the edge 30d of the antireflection film 30 and the side surface 22b of the lens portion 22. The liquid crystal display device 100B′ shown in FIG. 17 is advantageous in that the antireflection film 30 is prevented from peeling off.

In the above example, the protection tape 50 is provided in the liquid crystal display device 100B′ where the edge 30d of the antireflection film 30 is on the side surface 22b of the lens portion 22 (FIG. 17). However, in a liquid crystal display device where the edge 30d of the antireflection film 30 is on the rear surface 22c of the lens portion 22 as in the liquid crystal display device 100C shown in FIG. 12, the edge 30d may be attached onto the side surface 22b and/or the rear surface 22c of the lens portion 22 by means of the protection tape 50. By attaching the protection tape 50, the antireflection film 30 is more effectively prevented from peeling off.

Next, a liquid crystal display device 200A which has a large screen formed by the liquid crystal display panels 10 using a tiling technique is described with reference to FIG. 18. The liquid crystal display device 200A shown in FIG. 18 includes two liquid crystal display panels 10 and two light-transmitting covers 20. FIG. 18 is a schematic enlarged cross-sectional view showing a joint portion of the two liquid crystal display panels 10 of the liquid crystal display device 200A. Note that the tiling may be realized according to a known method.

The two liquid crystal display panels 10 are arranged so as to adjoin each other along the second direction D2 (the horizontal direction in FIG. 18). Here, the second direction D2 is perpendicular to the first direction D1 (see FIG. 1). The viewer's side of each of the liquid crystal display panels 10 is provided with the light-transmitting cover 20. As shown in FIG. 18, the light exit surface 22a and the side surface 22b of the lens portion 22 of the light-transmitting cover 20 is covered with the antireflection film 30. The two light-transmitting covers 20 are arranged such that the lens portions 22 adjoin each other along the second direction D2. The edge 30d of the antireflection film 30 is on the side surface 22b of the lens portion 22.

The liquid crystal display device 200A includes a protection tape 50. The protection tape 50 includes a support layer 52 and two adhesion layers (the first adhesion layer 54 and the second adhesion layer 56). That is, the protection tape 50 is a double-sided tape. The first adhesion layer 54 is provided on one side of the support layer 52. The second adhesion layer 56 is provided on the other side of the support layer 52.

As shown in FIG. 18, the protection tape 50 unites the two light-transmitting covers 20 together at the side surfaces 22b. The edges 30d of the antireflection films 30 and the side surfaces 22b of the lens portions 22 which have been attached onto the respective light-transmitting covers 20 are covered with the protection tape 50. By using the protection tape 50 which has the adhesion layers on both sides, the antireflection films 30 is prevented from peeling off, as in the liquid crystal display device 100B′ shown in FIG. 17, even when the liquid crystal display panels 10 are used for tiling. Thus, the protection tape 50 advantageously has two functions, combining the two light-transmitting covers 20 together and preventing the antireflection films 30 from peeling off.

In the liquid crystal display device 200A, portions of the protection tape 50 and the antireflection films 30 extending over the side surfaces 22b of the lens portions 22 constitute part of the non-display region that does not contribute to displaying. Therefore, the protection tape 50 is preferably as thin as possible. For example, the protection tape 50 is preferably attached such that the distance L2 along the second direction D2 between the side surfaces 22b of the lens portions 22 of the respective light-transmitting covers 20 is not more than 100 pm.

In a liquid crystal display device in which the liquid crystal display panels 10 are used for tiling, such as the liquid crystal display device 200A shown in FIG. 18, the antireflection films 30 may be attached such that the edges 30d of the antireflection films 30 are present on the rear surfaces 22c of the lens portions 22, while the two light-transmitting covers 20 are united together at the side surfaces 22b by the protection tape 50. In this case, the non-display region is also preferably not more than 100 pm. Further, in this case, the edges 30d of the antireflection films 30 may be attached onto the side surfaces 22b and/or rear surfaces 22c of the lens portion 22 using the protection tape 50.

The liquid crystal display panel 10 and the light-transmitting cover 20 may be combined according to a known method. For example, as shown in FIGS. 19(a) and 19(b), the liquid crystal display panel 10 and the light-transmitting cover 20 may be combined together via a buffer layer 80. The refractive index of the buffer layer 80 is preferably close to the refractive index of the light-transmitting cover 20 and the refractive index of a component which is provided on the viewer's side of the liquid crystal display panel 10 (e.g., the upper substrate) because the interface reflection can be prevented, and the display quality can be improved. In the case where the liquid crystal display device includes a backlight device, the transmittance of light emitted from the backlight device can be improved. Therefore, improvement in luminance of the display device and reduction in power consumption can advantageously be realized.

An example where a UV-curable resin is used as the material for the buffer layer 80 is now described with reference to FIGS. 19(a) and 19(b). FIGS. 19(a) and 19(b) are schematic cross-sectional views for illustrating the step of combining the liquid crystal display panel 10 and the light-transmitting cover 20 together.

As shown in FIG. 19(a), the liquid crystal display panel 10 is supported on a flat stage 91. A UV-curable resin 80′ of an appropriate amount is applied onto the display surface 19 of the liquid crystal display panel 10. Meanwhile, the light-transmitting cover 20 is supported on a flat stage 92 such that the rear surface 20b of the light-transmitting cover 20 opposes the display surface 19 of the liquid crystal display panel 10. The UV-curable resin 80′ may be, for example, dropped onto the display surface 19 of the liquid crystal display panel 10.

Then, as shown in FIG. 19(b), the liquid crystal display panel 10 is moved in a direction perpendicular to the display surface 19 relative to the light-transmitting cover 20, thereby combining the liquid crystal display panel 10 and the light-transmitting cover 20 together. The step of combining is preferably performed in a reduced pressure atmosphere such that air bubbles are not contained in the UV-curable resin 80′. Here, the reduced pressure atmosphere is preferably in the range of, for example, from 1.5×10⁻⁴ MPa to 3.0×10⁻³ MPa.

Then, the UV-curable resin 80′ is irradiated with ultraviolet light so as to be cured.

In this way, the liquid crystal display panel 10 and the light-transmitting cover 20 can be combined together via the buffer layer 80. Note that, after irradiation with ultraviolet light, the UV-curable resin 80′ may be heated so that the curing may be accelerated.

The element used for combining the liquid crystal display panel 10 and the light-transmitting cover 20 together may be an adhesive material which is in the form of a sheet, such as a pressure sensitive adhesive sheet, a gel sheet, or the like. When the sheet element is used to combine the display panel and the light-transmitting cover together, the sheet element is placed over the display surface 19 of the liquid crystal display panel 10 supported on the flat stage with pressure being applied by means of a pressure application element, such as a roller. Then, the light-transmitting cover 20 supported on the flat stage 92, for example, is combined with the liquid crystal display panel 10. The step of combining the liquid crystal display panel 10 and the light-transmitting cover 20 together is preferably performed in a reduced pressure atmosphere for the same reason as that described above. In this way, the liquid crystal display panel 10 and the light-transmitting cover 20 can be combined together. By using an adhesive sheet element, even if the combination fails due to entry of air bubbles or external materials in the manufacture process, reworking is readily enabled so that the manufacturing yield can be improved.

The antireflection film may be a know antireflection film.

The antireflection film may be a coat-type low reflection film (LR film). The coat-type low reflection film is formed by coating a base with a resin material of a low refractive index such that the coat has a predetermined thickness. By providing a coat-type low reflection film, the reflectance can be decreased to about 1%.

Alternatively, an antireflection film which is formed by a dielectric multilayer film (also referred to as “AR film”) may be used. The dielectric multilayer film is obtained by, for example, stacking layers of two or more inorganic dielectric materials having different refractive indices over a film of PET, or the like, by means of vapor deposition, or the like, such that the respective layers have predetermined thicknesses. The dielectric multilayer film enables reducing the reflectance to about 0.2% due to an interference effect.

The antireflection film may have a motheye structure. An antireflection film which has a motheye structure may be fabricated, for example, as described below.

An aluminum base is provided, and an anodization step and an etching step are repeated, whereby a stamper is fabricated which has a structure of recessed and raised portions in its surface. Then, the stamper is pressed on a PET film which is, for example, coated with an UV-curable resin (e.g., urethane acrylate resin) over its surface, and the resin is irradiated with ultraviolet light (for example, irradiated with ultraviolet light at the wavelength of 365 nm, with the intensity of 10 mW, for 360 seconds). As a result, a resin antireflection film is obtained, which has a structure of recessed and raised portions such that the two-dimensional size and the interval of the recessed and raised portions, when seen in a direction normal to the surface, are not less than 10 nm and less than 500 nm. The antireflection film which has the motheye structure enables reducing the reflectance to about 0.2% (see WO 2006/059686 and WO 2009/019839). Note that the entire disclosures of WO 2006/059686 and WO 2009/019839 are incorporated by reference in this specification.

As for the display quality of the display devices which include the antireflection films, the display device which includes the coat-type low reflection film has better display quality than the display device which includes the dielectric multilayer film, and the display device which includes the dielectric multilayer film has better display quality than the display device which includes the motheye structure antireflection film. This difference in display quality is attributed to the difference in reflectance among the three types of antireflection films.

Among the coat-type low reflection film, the dielectric multilayer antireflection film, and the motheye structure antireflection film, the coat-type low reflection film and the motheye structure antireflection film are relatively flexible and therefore advantageous when being attached onto a curved surface as in the above-described display device embodiments.

Here, the result of a ray-tracing simulation for a liquid crystal display device of the present embodiment is described with reference to FIG. 20. FIG. 20 shows the result of a ray-tracing simulation for the liquid crystal display device 200B in which the two liquid crystal display panels 10 are arranged along the second direction D2, the simulation being performed in the vicinity of the joint portion between the two liquid crystal display panels 10.

The liquid crystal display device 200B includes two liquid crystal display panels 10 and two light-transmitting covers 20. The two liquid crystal display panels 10 are arranged so as to adjoin each other along the second direction D2. Here, the second direction D2 is perpendicular to the first direction D1 (see FIG. 1). The light-transmitting covers 20 are provided on the viewer's side of the respective liquid crystal display panels 10. As shown in FIG. 20, the antireflection film 30 is attached onto the light exit surface, the side surface and the rear surface 22c of the lens portion 22 of the light-transmitting cover 20. The edge 30d of the antireflection film 30 is on the rear surface 22c of the lens portion 22. The two light-transmitting covers 20 are arranged such that the lens portions 22 adjoin each other along the second direction D2.

As shown in FIG. 20, light rays going out from the pixels arrayed in the peripheral display regions 10D enter the lens portions 22 and then are refracted to go toward the viewer, traveling in a direction perpendicular to the display surface 19. Thus, an image formed in the peripheral display regions 10D is enlarged so as to be displayed over a region constituted of the peripheral display regions 10D and the frame regions 10F. Therefore, the frame regions 10F are obscured.

The frame regions 10F of the two liquid crystal display panels 10 constitute a non-display region 10G. In the liquid crystal display device 200B, the frame regions 10F of the two liquid crystal display panels 10 are obscured. When seen in a direction perpendicular to the display surface 19, the non-display region 10G is obscured. Moreover, since the lens portions 22 are provided with the antireflection films 30, reflection of external light is prevented, so that the display quality is high.

Thus, by attaching the antireflection film onto the light exit surface and the side surface of the lens portion, or by attaching antireflection film onto the light exit surface, the side surface and the rear surface of the lens portion, the antireflection film is prevented from peeling off, and the display quality is improved. When a plurality of display panels are combined together using a tiling technique (in the case of a so-called multi display or seamless display), the combined panels are recognized as a single display device, without a sense of discontinuity, so that the display quality improves.

The light-transmitting cover may be manufactured using, for example, an acrylic material by cutting or injection molding. The material for the light-transmitting cover may be, for example, a transparent resin, such as polycarbonate, or a light-transmitting material, such as glass.

In the above examples, the antireflection film is attached via an adhesion layer. The material for the adhesion layer may be a pressure sensitive adhesive. When the pressure sensitive adhesive is used, as in the case of an adhesive agent for use in combining together the liquid crystal display panel and the light-transmitting cover which have been described above, even if the combination fails due to entry of air bubbles or external materials in the manufacture process, reworking is readily enabled so that the manufacturing yield can be improved.

Next, the shape of the light exit surface of the lens portion is described. The line of intersection between the light exit surface of the lens portion and a plane perpendicular to the boundary (the boundary between the display region and the frame region, which is designated by B1 in FIG. 1) may be, for example, a circular arc. Alternatively, a line of intersection between the light exit surface 22a and a plane perpendicular to the boundary B1 may be a curve which is not a circular arc. For example, it may be a curve which is defined by an aspherical function. Particularly, it is preferred that the line of intersection is a curve defined by an aspherical function described in WO 2009/157150. The entire disclosure of WO 2009/157150 is incorporated by reference in this specification.

A liquid crystal display device 100H is described with reference to FIG. 21, in which a line of intersection between the light exit surface 22a and a plane perpendicular to the boundary B1 is a curve defined by an aspherical function described in WO 2009/157150.

FIG. 21 is a schematic enlarged cross-sectional view of part of the liquid crystal display device 100H in the vicinity of the lens portion 22. As shown in FIG. 21, the liquid crystal display device 100H includes the liquid crystal display panel 10 and the light-transmitting cover 20. The light-transmitting cover 20 includes the lens portion 22 and the flat portion 24. The light exit surface 22a and the side surface 22b of the lens portion 22 are covered with the antireflection film 30.

In FIG. 21, broken lines represent light rays which go out from the pixels arrayed in the display region 10A. As shown in FIG. 21, light rays going out from the pixels arrayed in the peripheral display region 10D enter the lens portion 22 and are refracted in the frame region 10F.

For example, the shape of the viewer-side surface 22a of the lens portion 22 can be obtained as described below which is configured such that an image that has been formed in the peripheral display region 10D at an image compression rate a relative to an image formed in the central display region 10B is enlarged by 1/a times so as to be displayed over the viewer-side surface 22a of the lens portion 22.

The aspherical function f(x) used herein is as follows:

f(x)=h−cx²/(1+(1−(1+k)c²x²)^{1/2})+A₄x⁴+A₆x⁶+A₈x⁸+A₁₀x¹⁰

where

c: curvature of the lens portion 22 (an inverse of the radius of curvature),

h: thickness of the flat portion 24, and

k: conic constant.

x represents the position of each point on the viewer-side surface 22a of the lens portion 22 along the second direction D2. Zero (0) is set on the central display region 10C side. The value increases as the position becomes closer to the frame region 10F.

Assuming that, for example:

width L1 of the peripheral display region 10D: 12 mm;

width L2 of the frame region 10F: 3 mm;

image compression rate a: 0.8

thickness h of the flat portion 24: 13 mm;

radius of curvature (an inverse of the curvature c of the lens portion 22, i.e., 1/c): 23 mm; and

refractive index n of the lens portion 22: 1.49 (acrylic resin),

the coefficients of the function have the following values.

k=1.15

A₄=−7.86×10⁻⁷

A₆=1.89×10⁻⁸

A₈=−1.62×10⁻¹⁰

A₁₀=4.95×10⁻¹³

The value of k is expressed by the following formula when a=0.4 to 0.89:

k=89.918a⁴−194.57a³+159.82a²−57.099a+7.1865

When the image compression rate is small (e.g., a<0.7), the value of 1/a is large, so that each pixel is greatly enlarged. This can make the black matrix between adjacent pixels conspicuous, resulting in undesirable display in many cases. On the other hand, a large image compression rate (e.g., a>0.9) is not so preferred because a large lens portion is necessary as compared with the width of the frame region. For example, when the image compression rate a is 0.95, a=L1/(L1+L2)=0.95. Thus, the width of the lens portion, L1+L2, is 20 times the width L2 of the frame region. If the width L2 of the frame region is 3 mm as in the above example, the width of the lens portion, L1+L2, is 60 mm. For example, many of the display devices for use in mobile phones have the device width of not more than 60 mm, and therefore, a lens element whose lens portion width L1+L2 is 60 mm cannot be placed. Therefore, the image compression rate a is preferably about 0.7 to 0.9. Based on the above formula, the values of conic constant k for the image compression rate a=0.7, 0.9 are calculated to be k≈0.38, 2.4, respectively. Thus, the preferred range of conic constant k is not less than 0.38 and not more than 2.4.

The above aspherical function f(x) is obtained using the above value of k, and the lens portion 22 which has the light exit surface 22a represented by f(x) is manufactured, whereby an undistorted image can be displayed in the peripheral display region 10D and the frame region 10F.

When a cross section of the light exit surface 22a of the lens portion 22 is a curve which is defined by the above aspherical function, the light rays going out from the light exit surface 22a of the lens portion 22 toward the viewer occur at an equal interval along the second direction D2 as shown in FIG. 21. In other words, when a cross section of the light exit surface 22a of the lens portion 22 is a curve which is defined by the above aspherical function, the lens portion 22 refracts light rays going out from a plurality of pixels arrayed in the peripheral display region 10D of the display region 10A in such a manner that the light rays occur at a generally constant pitch along the second direction D2 (i.e., at a generally constant pitch across a plane perpendicular to the first direction D1). Therefore, the liquid crystal display device 100H is capable of displaying an undistorted image over a region constituted of the peripheral display region 10D and the frame region 10F.

The liquid crystal display panel 10 may be any type of known liquid crystal display panel. The liquid crystal display panel 10 includes an upper substrate 11 and a lower substrate 12, and further includes a liquid crystal layer 13 between the upper substrate 11 and the lower substrate 12. The lower substrate 12 has, for example, TFTs and pixel electrodes. The upper substrate 11 has, for example, a color filter layer and a counter electrode. The upper side of the upper substrate 11 and the lower side of the lower substrate 12 are provided with polarizers as necessary. The frame region 10F of the liquid crystal display panel 10 includes a sealing portion 16, a driving circuit, etc. Under the liquid crystal display panel 10, a backlight device 40 is provided. The backlight device 40 is, for example, a direct lighting type backlight device which includes a plurality of fluorescent tubes that are parallel to one another.

In either of the above-described liquid crystal display devices 100A (FIG. 1), 100B (FIG. 9), 100C (FIG. 12), 100D (FIG. 13), 100E (FIG. 14), 100F (FIG. 15), 100G (FIG. 16), 100H (FIG. 21), 200A (FIGS. 18) and 200B (FIG. 20), only the light exit surface 22a of the lens portion 22 is formed by a curved surface. However, both the light exit surface and the rear surface of the lens portion may be formed by curved surfaces. When the both surfaces of the lens portion are formed by curved surfaces, light coming in the lens portion is refracted twice before going out from the lens portion. Therefore, as compared to a case where only one side is formed by a curved surface, light can be largely refracted within a short optical distance. Thus, even when the radii of curvature of the light exit surface 22a and the rear surface 22c of the lens portion 22 are greater than that of a display device in which only one side of the lens portion is formed by a curved surface, equivalent optical characteristics can be achieved. As the radius of curvature increases, the thickness of the lens portion can be decreased. Therefore, when the light exit surface 22a and the rear surface 22c of the lens portion 22 are formed by curved surfaces, the thickness and the weight of the lens portion 22 can advantageously be reduced.

When both surfaces of the lens portion are curved surfaces, both a line of intersection between the light exit surface and a plane which is perpendicular to the boundary (the boundary between the display region and the frame region, which is designated by B1 in FIG. 1) and a line of intersection between the rear surface and a plane which is perpendicular to the boundary are, for example, circular arcs. Alternatively, at least one of these intersection lines may be a curve which is defined by an aspherical function. Alternatively, at least one of the light exit surface and the rear surface may be another free curved surface (see WO 2009/157161). The entire disclosure of WO 2009/157161 is incorporated by reference in this specification.

As described above, according to the present invention, a direct-viewing type display device can be provided in which the frame region of a display panel is obscured and in which reflection of the environment in the lens portion is prevented.

### INDUSTRIAL APPLICABILITY

The present invention is suitably applicable to display devices for television sets and display devices for displaying information.

### REFERENCE SIGNS LIST

10 liquid crystal display panel

10A display region

10C central display region

10D peripheral display region

10F frame region

19 display surface of display panel

20 light-transmitting cover

22 lens portion

22a light exit surface

22b side surface

22c rear surface

24 flat portion

30 antireflection film

100A liquid crystal display device

B1 boundary

D1 first direction

1. A direct-viewing type display device, comprising:
at least one display panel which has a display region and a frame region provided outside the display region, the display region and the frame region being separated by a boundary extending in a first direction; and
at least one light-transmitting cover provided on a viewer side of the at least one display panel;
wherein the at least one light-transmitting cover includes a lens portion which is disposed astride the boundary, the lens portion being configured to refract part of light going out from the display region in the frame region, and
a light exit surface of the lens portion is a curved surface, at least part of the light exit surface being provided with an antireflection treatment.

2. The display device of claim 1, further comprising an antireflection film, wherein
the antireflection film is attached onto the light exit surface of the lens portion and a side surface of the lens portion via an adhesion layer, and
an edge of part of the antireflection film which is attached onto the side surface of the lens portion is on the side surface of the lens portion.

3. The display device of claim 1, further comprising an antireflection film, wherein
the antireflection film is attached onto the light exit surface of the lens portion, a side surface of the lens portion, and a rear surface of the lens portion via an adhesion layer, and
an edge of part of the antireflection film which is attached onto the rear surface of the lens portion is on the frame region side of the boundary.

4. The display device of claim 1, further comprising an antireflection film, wherein
the antireflection film is attached onto the light exit surface of the lens portion, a side surface of the lens portion, and a side surface of the at least one display panel via an adhesion layer, and
an edge of part of the antireflection film which is attached onto the side surface of the display panel is on the side surface of the display panel.

5. The display device of claim 1, further comprising an antireflection film, wherein
the antireflection film is attached onto the light exit surface of the lens portion, a side surface of the lens portion, a side surface of the at least one display panel, and a rear surface of the at least one display panel via an adhesion layer, and
an edge of part of the antireflection film which is on the rear surface of the display panel is on the frame region side of the boundary.

6. The display device of claim 2, wherein a corner of the lens portion at which the light exit surface and the side surface of the lens portion meet each other has a curved surface.

7. The display device of claim 3, wherein
a corner of the lens portion at which the light exit surface and the side surface of the lens portion meet each other has a curved surface, and
another corner of the lens portion at which the side surface and the rear surface of the lens portion meet each other has a curved surface.

8. The display device of claim 2, further comprising a protection tape which includes a support layer and a first adhesion layer provided on one surface of the support layer, wherein
the protection tape is attached so as to cover an edge of part of the antireflection film which is attached onto the side surface of lens portion and the side surface of the lens portion.

9. The display device of claim 8, wherein
the protection tape further includes a second adhesion layer provided on the other surface of the support layer,
the at least one display panel includes two display panels arranged so as to adjoin each other along a second direction which is perpendicular to the first direction,
the at least one light-transmitting cover includes two light-transmitting covers arranged so as to adjoin each other along the second direction,
the lens portions of the two light-transmitting covers adjoin each other along the second direction,
the lens portions of the two light-transmitting covers are covered with the antireflection film via an adhesion layer,
the two light-transmitting covers are united together by means of the protection tape, and
a dimension along the second direction of the side surface of the lens portions of the two light-transmitting covers is not more than 100 μm.

10. A method of manufacturing a display device, comprising the steps of:
(a) providing a light-transmitting cover which includes a lens portion at its edge, a light exit surface of the lens portion being formed by a curved surface;
(b) attaching an antireflection film onto the light exit surface of the lens portion via an adhesion layer with pressure; and
(c) after step (b), attaching the antireflection film onto a side surface of the lens portion with pressure.

11. The method of claim 10 further comprising, between step (a) and step (b) or between step (b) and step (c), step (d) of cutting the antireflection film such that an edge of part of the antireflection film attached onto the side surface is present on the side surface of the lens portion.

12. The method of claim 10, wherein step (a) includes providing a display panel unit, the display panel unit including a display panel and the light-transmitting cover.
